(19) United States
(12) Patent Application Publication
(10) Pub. No.: US 2007/0042102 A1
(43) Pub. Date: Feb. 22, 2007

(54) Methods of forming phytosterol-fortified cocoa powder and the product formed therefrom

(76) Inventor: Steven J. Furcich, Monticello, IL (US)

Correspondence Address: KIRKPATRICK & LOCKHART NICHOLSON GRAHAM LLP;HENRY W. OLIVER BUILDING, 535 SMITHFIELD STREET, PITTSBURGH, PA, 15222, US

(21) Appl. No.: 11/507,258

(22) Filed: Aug. 21, 2006

Related U.S. Application Data
(60) Provisional application No. 60/710,224, filed on Aug. 22, 2005.

(51) Int. Cl. A23G 1/04

(52) U.S. Cl. 426/631

(57) ABSTRACT

Cocoa powder fortified with phytosterols is provided, and methods for making such cocoa powders.

### CROSS-REFERENCE TO RELATED APPLICATIONS

This application claims the benefit of U.S. Provisional App. No. 60/710,224, filed on Aug. 22, 2005, the entire teachings of which are incorporated herein by reference.

### FIELD OF THE INVENTION

The present invention is directed to cocoa powder enriched with phytosterol, and methods of making it.

### BACKGROUND

More than 750,000 people in the United States die from coronary heart disease and strokes every year. About 1.25 million people suffer from heart attacks every year, half of which occur without warning. Coronary heart disease is the most common cause of death among men and women in the United States. Despite a century of drug development, presently ten times as many Americans die of heart attacks as at the turn of the century.

According to the American Heart Association, serum cholesterol levels are a major predictor of cardiovascular disease. Cholesterol, a soft, waxy substance found among the lipids in the blood stream, is important to proper body function because it is used to form cell membranes, some hormones and other necessary bodily tissues. However, a high level of cholesterol in the blood (hypercholesterolemia) is a major risk factor for coronary heart disease, and has been linked to heart attack.

Cholesterol has been known for many years to be a component of atherosclerotic plaques. Mounting evidence supports the finding that diets high in cholesterol may increase the levels of cholesterol in the blood which, in turn, increase the risk of atherosclerotic disease and its attendant manifestations of heart attack, stroke and other tissue injuries resulting from atherosclerosis. Cholesterol absorbed from dietary sources is thought to increase the risk of atherosclerotic disease.

There is, therefore, a need for products containing plant phytosterols, which can be used by consumers as part of an overall strategy against cardiovascular disease, and which are safe enough to be taken without direct medical supervision.

### SUMMARY OF THE INVENTION

Compositions of cocoa powder enriched with phytosterols are provided, and methods for making such cocoa powders.

Provided herein is a method of making an enriched cocoa powder, the method comprising: combining cocoa presscake, cocoa powder, or a combination of cocoa presscake and cocoa powder with a phytosterol, thus producing the enriched cocoa powder. The method can also include grinding roasted cocoa beans, thus producing a cocoa mass, removing cocoa butter from the cocoa mass, thus producing a presscake, spraying the phytosterol in liquid form onto the presscake, and grinding the presscake, thus producing the enriched cocoa powder.

Also provided herein is a composition comprising: an isolated or purified phytosterol, and cocoa powder.

Also provided herein is an enriched cocoa powder, made by any of the methods described herein.

Additionally provided is a food product comprising the enriched cocoa powder. Such a food product can be configured such that a serving size of the food product provides between 400 to 1000 mg of the phytosterols to a subject consuming the food product. Also provided is a container configured to hold such a food product, comprising indicia configured to inform a user of the food product of the phytosterol content of the food product associated with the container.

Provided herein is a method for making cocoa powder enriched with a phytosterol, where the method includes: providing cocoa presscake, adding phytosterol to the cocoa presscake to make cocoa presscake with added phytosterol, and grinding the cocoa presscake with added phytosterol to make cocoa powder, thus making cocoa powder enriched with a phytosterol.

Also provided is a method for making cocoa powder enriched with a phytosterol, where the method includes: providing cocoa presscake, grinding the cocoa presscake to make cocoa powder, and during the grinding, adding phytosterol to the cocoa presscake, thus making cocoa powder enriched with a phytosterol.

Another method is provided for making cocoa powder enriched with a phytosterol, where the method includes: providing one or more batches of cocoa powder, adding phytosterol to one or more of the batches of cocoa powder, and blending the phytosterol and the one or more batches of cocoa powder, thus making cocoa powder enriched with a phytosterol.

Further provided is phytosterol-enriched cocoa powder.

Also provided is phytosterol-enriched cocoa powder, made by the method including providing cocoa presscake, adding phytosterol to the cocoa presscake to make cocoa presscake with added phytosterol, and grinding the cocoa presseake with added phytosterol to make cocoa powder.

Provided herein is also phytosterol-enriched cocoa powder, made by the method comprising providing cocoa presscake, grinding the cocoa presscake to make cocoa powder, and during the grinding, adding phytosterol to the cocoa presscake, thus making cocoa powder enriched with a phytosterol.

Additionally provided is phytosterol-enriched cocoa powder, made by the method comprising providing one or more batches of cocoa powder, adding phytosterol to one or more of the batches of cocoa powder, and blending the phytosterol and the one or more batches of cocoa powder, thus making cocoa powder enriched with a phytosterol.

In any of the methods and compositions described herein, the phytosterol can be sitosterol, sitostanol, campesterol, campestanol, stigmasterol, stigmastanol, brassicasterol, brassicasterol, or a mixture thereof. The presscake can be made from cocoa beans which have been alkalized, or the cocoa powder may be alkalized after it is enriched with phytosterols. The phytosterol can be provided in solid form, liquid form or powder form. The phytosterol can be added by spraying.

In any of the methods and compositions described herein, the phytosterol can be added to cocoa powder at a rate between about 1 gram phytosterol per kilogram cocoa powder to about 600 grams phytosterol per kilogram cocoa powder, or between about 100 grams phytosterol per kilogram cocoa powder to about 300 grams phytosterol per kilogram cocoa powder. The phytosterol can be added at a rate of about 200 grams per kilogram cocoa powder.

Lignan also can be added to the cocoa presscake, cocoa powder, combination of cocoa presscake and cocoa powder, or to the enriched cocoa powder.

It should be understood that this invention is not limited to the embodiments disclosed in this summary, or the description that follows, but it is intended to cover modifications that are within the spirit and scope of the invention, as defined by the claims.

### DETAILED DESCRIPTION

Other than in the examples herein, or unless otherwise expressly specified, all of the numerical ranges, amounts, values and percentages, such as those for amounts of materials, elemental contents, times and temperatures of reaction, ratios of amounts, and others, in the following portion of the specification and attached claims may be read as if prefaced by the word “about” even though the term “about” may not expressly appear with the value, amount, or range. Accordingly, unless indicated to the contrary, the numerical parameters set forth in the following specification and claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains error necessarily resulting from the standard deviation found in its underlying respective testing measurements. Furthermore, when numerical ranges are set forth herein, these ranges are inclusive of the recited range end points (i.e., end points may be used). When percentages by weight are used herein, the numerical values reported are relative to the total weight.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10. The terms “one,” “a,” or “an” as used herein are intended to include “at least one” or “one or more,” unless otherwise indicated.

Any patent, publication, or other disclosure material, in whole or in part, that is said to be incorporated by reference herein in its entirety is incorporated herein only to the extent that the incorporated material does not conflict with existing definitions, statements, or other disclosure material set forth in this disclosure. As such, and to the extent necessary, the disclosure as explicitly set forth herein supersedes any conflicting material said to be incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

The present invention includes cocoa powder enriched with phytosterol, and methods of making such cocoa powders. Such cocoa powders are useful for making confectionary compositions which may help to maintain or reduce the consumer's serum cholesterol level.

Plant sterols or phytosterols refer to the sterols appearing in the plant kingdom which closely resemble cholesterol in terms of structure. They are, like cholesterol in mammals, a structural component of external and internal membranes and are, thus, essential constituents for the living functions of cells.

Cholesterol is insoluble in the blood, and must be transported to and from the cells by lipoproteins. There are several kinds of lipoproteins, the most important of which are low-density lipoprotein (LDL) and high-density lipoprotein (HDL).

Low-density lipoprotein is the major cholesterol carrier in the blood. Excess LDL cholesterol circulating in the blood can slowly build up within the walls of the arteries feeding the heart and brain. Together with other substances it can form plaque, a thick, hard deposit that can clog the arteries, a condition known as atherosclerosis. The formation of a clot (or thrombus) in the region of this plaque can block the flow of blood to part of the heart muscle and cause a heart attack. If a clot blocks the flow of blood to part of the brain, the result is a stroke. A high level of LDL cholesterol reflects an increased risk of heart disease. Thus, LDL cholesterol is sometimes referred to as “bad cholesterol.”

High density lipoprotein (“HDL”) carries about one-third to one-fourth of blood cholesterol. It is believed that HDL carries cholesterol away from the arteries and back to the liver, from which it is ultimately passed from the body. Some experts believe HDL removes excess cholesterol from atherosclerotic plaques and, thus, slows their growth. HDL is known as “good cholesterol” because a high level of HDL appears to protect against heart attack. The opposite may also be true: a low HDL level indicates a greater risk of a heart attack. Thus, the risk of having a heart attack or stroke may be strongly predicted by the amounts of low-density lipoprotein (LDL), high-density lipoprotein (HDL), and triglycerides in the blood.

Cholesterol generally comes from two sources. Endogenic cholesterol is produced in the body, mostly in the liver (approximately 1,000 milligrams a day). Dietary cholesterol is found in foods that come from animals, such as meat, poultry, fish, seafood and dairy products. In contrast, foods from plants (fruits, vegetables, grains, nuts and seeds) do not contain cholesterol. When ingested, dietary cholesterol increases the cholesterol level in blood and may act as a main cause of cardiovascular diseases, including hyperlipidemia, arteriosclerosis, arrhythmia, cardiac infarction, and the like. Both endogenic and dietary cholesterol pass through the small intestine, where about half is absorbed into the bloodstream. This level of absorption may be reduced through the practice of the present invention.

Cholesterol and triglyceride levels can be reduced through medical intervention and/or dietary modification, such as reduction of the dietary intake of cholesterol and saturated fats. However, some dietary modifications have given rise to new problems. For example, in recent years the substitution of margarine for butter has been promoted. Butter is high in cholesterol and saturated fats. Stick margarine, on the other hand, has a semi-solid consistency based on the presence of hydrogenated oils. The hydrogenation process, however, forms trans fats. Clinical studies have demonstrated that trans fats are atherogenic, causing two to three times the cardiovascular risk of the naturally saturated fats which give buffer its stability. The health advantage of margarine when compared to buffer is now suspect, as margarine, particularly stick margarine, may contain 20% to 30% of trans fats. Presently, the American Heart Association recommends the use of commercially available soft margarine, or trans-free margarine, which is formulated from either completely hydrogenated palm oil or palm oil fractions. This form of margarine, while free of trans fats, contains increased levels of saturated fats, the second most dangerous component of margarine.

Other compounds that have been studied in connection with the treatment and prevention of diseases including arteriosclerosis and high cholesterol levels include statins. Statins block HMGCOA reductase. Statins also sometimes cause liver dysfunction, or other undesirable effects such as myopathy.

In many cases, however, patients taking statins may respond to the decreased rate of cholesterol synthesis by a compensatory increase in the rate at which dietary cholesterol is absorbed from food. A recent study reports that 80% of patients taking statins as a monotherapy failed to reach treatment goals. With respect to statins, increasing the dosage to the levels frequently required to overcome compensatory increase in cholesterol absorption, produces an 11-fold increase in the incidence of liver complications as noted above. Because of the risk of liver complications, statins must be taken under a doctor's supervision.

Other compounds have been reported to reduce cholesterol levels in humans. For example, plant sterols, particularly beta-sitosterol, have been reported to have anticholesterolemic effects, and are believed to inhibit cholesterol absorption in the small intestine.

A commercial margarine first introduced in Finland, Benecol®, a registered trademark of Raiso Benecol Oy Corporation, contains hydrogenated plant sterols extracted from pulp and paper waste, and has been said to achieve a 10-15% reduction in cholesterol levels in patients substituting Benecol® margarine for standard margarine in their diets. This reduction corresponds to a twenty to thirty percent decrease in cardiovascular risk.

Plant sterols are thought to displace cholesterol in bile salt micelles. Approximately half of the dietary cholesterol ingested is absorbed whereas less than 5% of beta-sitosterol is absorbed. When the plant sterols displace cholesterol of the bile salt micelles, the cholesterol is fecally excreted.

Sterols are a subtype of steroids, and include cholesterol, phytosterols, and some steroid hormones. Stanols are completely saturated forms of sterols and lack the carbon-carbon double bonds found in sterols. In plants, sterols are more abundant than stanols, and beta-sitosterol, stigmasterol, and campesterol, are, generally, the most abundant.

Phytosterols have been reported to lower LDL cholesterol levels with little or no effect on high-density lipoprotein (HDL) cholesterol or triglyceride levels, and the effect appears to be consistent across different types of diets. A number of products are now commercially available which contain phytosterols, either added to the product or used as a replacement fat. Many of these produts are described in various publications.

For example, U.S. Pat. No. 6,743,450 discloses methods for extracting from cocoa hulls cocoa oil that is high in sterols. U.S. Pat. No. 6,326,050 discloses a composition of an oil/fat containing specified levels of diacylglycerol, free phytosterol and a tocopherol. U.S. Pat. No. 6,441,206 discloses fat compositions that contain specific esters of phytosterols.

U.S. App. No. 2003/0068425 discloses compositions containing steryl esters, which can be incorporated into confectionary products. The ester moiety is a blend of fatty acids and having at least 80% oleic acid. U.S. Pat. No. 6,391,370 discloses the micromilling of sterols, stanols, and esters with emulsifiers to produce a dispersion that can be incorporated into food products. U.S. App. No. 2004/0105931 discloses alcoholysis of a free sterol, and adding the resulting composition to food products. WO 03/064444 discloses an edible composition containing a phytosterol or phytosterol ester and diacylglycerol in oil or fat. The composition can be used in food products, and the like. U.S. Pat. No. 6,352,737 discloses “nanoscale” sterols and sterol esters with diameters of 10-300 nm, for use as food additives.

U.S. App. No. 2002/0064548 discloses a method of dispersing plant sterols in aqueous substrates, especially beverages, by mixing the sterols with an emulsifier.

WO 01/78529 discloses foods and food additives containing cocoa polyphenols (e.g., sterol or stanol based cholesterol-lowering agents), or polyphenols from other sources. It also describes extraction of polyphenols, and that sterols can be added to the sugar, butter, cocoa nibs, or melted chocolate. The sterols can be mixed with a fat first, or added to melted chocolate.

WO 04/093571 discloses that adding sterols to cocoa beverages can mask bitter taste.

Plant sterols exist naturally in saturated and unsaturated forms, as free alcohols and as esters. The unsaturated forms dominate. Natural sitosterols may be converted to sitostanols by hydrogenation, and it has been reported that stanols are more effective per unit weight than sterols in blocking cholesterol absorption, and that stanols are not absorbed. Further, the amount of beta-sitosterol absorbed may be relatively constant even when doses administered vary by an order of magnitude. Both sterols and stanols have been used as relative markers of cholesterol absorption because of their unabsorbability.

Other than avoidance or reduced consumption of high cholesterol foods, non-prescription measures available to the general public to reduce the absorption of cholesterol from the diet have met with little success. Furthermore, in many cases, high serum cholesterol cannot be reduced by lowering dietary cholesterol. However, high cholesterol levels in serum may be lowered effectively by altering the intestinal metabolism of lipids. For example, certain plant sterols and plant stanols, such as beta-sitosterol (24-ethyl-5-cholestene-3-beta-ol) and its hydrogenated form (beta-sitostanol (24-ethyl-5-alpha-cholestane-3-beta-ol), may help to lower serum cholesterol by inhibiting cholesterol absorption in the digestive system. Many phytosterols are closely reminiscent of cholesterol in structure. Preventing cholesterol absorption of beta-sitosterol may be based on its ability to displace the cholesterol molecule in cholic acid/fat micelle (Ikeda et al., 1989, J. Nutr. Sci. Vitaminol. 35:361-369).

Plant sterols are natural components of vegetable fats and oils, and their use in food products is considered safe. Plant sterols are not absorbed from the intestine, or only absorbed in very small amounts. There are a variety of naturally occurring plant sterols which have been reported to have a cholesterol-reducing effect, although not all have equivalent action.

Sterols are a class of steroids that contain a hydroxy group at the C3 position and a branched aliphatic chain of 8-10 carbon atoms at the C17 position (Baileys Industrial Oil & Fat Products: General Applications, Vol. 1, pp. 402-403, John Wiley & Sons, Inc., New York, N.Y. (1996)). Phytosterols, i.e., plant sterols, are natural products obtained as byproducts of vegetable oil processing. Stanols are hydrogenated derivatives of sterols. Plant sterols and stanols, which are structurally similar to cholesterol, reduce cholesterol absorption and serum cholesterol levels in subjects and are themselves poorly absorbed. Solubility of free plant sterols and stanols is limited in oils and/or fats, which reduces the usefulness of the free sterols and stanols in cholesterol-reducing food products. To increase solubility, the sterols and stanols may be esterified with fatty acids. Steryl esters are compounds that contain a fatty acid linked to the C3 carbon of a phytosterol via an ester bond. Phytosterols are found in various plant oils including tall oils (from pine trees) and oilseeds such as corm, canola, soy, safflower, sunflower, rapeseed, cottonseed, and peanut. In oilseeds, the most abundant phytosterols are sitosterol (about 52 to 89% of total sterols), campesterol (about 2 to 30% of total sterols), and stigmasterol (up to 26% of total sterols).

With structures very similar to that of cholesterol, plant sternls are known to inhibit intestinal cholesterol absorption, thereby reducing the serum cholesterol level. Because they are naturally occurring, plant sterols are non-toxic and can be found in a wide variety of plants, such as, for example, bean, corm, wood, tall oil, and the like.

Sterols are also found in the cacao plant, albeit at relatively low levels. Most of the sterols found in cacao are in the cocoa butter, at levels of about 200 ppm (about 200 mg/Kg). For example, a 40 g chocolate bar typically contains approximately 1.6 mg of naturally-occurring plant sterols. The cocoa powder of the present invention, and products made therefrom, contains much higher amounts of sterols than does cocoa powder not made according to the present invention.

The cocoa powder of the present invention can also include added lignan. Lignans are secondary plant metabolites that are produced from shikimic acid via the phenylpropanoid pathway. Lignans develop from flavonoid precursors and aid in protecting plants from certain pathogens and predators. Lignans are defined as compounds possessing a 2,3-dibenzylbutane structure and include matairesinol, secoisolaricinesinol, lariuresinol, isolariciresinol, nordihydroguaiaretic acid, pinoresinol, olivil and other compounds, and modifications thereof, including diglucosides such as but not limited to herbacetin 3,8-O-diglucopyanoside, herbacetin 3,7-O-dimethyl ether and Kaempferol 3,7-O-diglucopyranoside. Diglycerides are known precursors of two important mammalian lignans dibenzylbutyrolactone enterolactone and dibenzyl butane enterodiol (Setchell et al., Biochem. J. 197:447-458 (1981)).

Numerous reports in literature have documented the phytochemical benefits of flaxseed lignans. Rickard et al. reported that feeding purified lignan at 5% flaxseed diet levels significantly reduces colon and mammary carcinogenesis in animals (Proceedings of the 57th Flax Institute of the United States, (Fargo, N. D.): 8-13 (1998)). Demark-Wahnefried et al. also reported that flaxseed supplementation may have a beneficial effect on prostate cancer biology (Demark-Wahnefried et al., Adult Urology 58(1): 47-52 (2001)).

Additionally, it has been reported that lignans prevent the development of Type I and Type II diabetes by 71% (Prasad, K. Proc. of the American Diabetes Association, (1999)), act as a hypotensive agent with ability to lower blood pressure without affecting heart rate, provide benefits against Lupus Nephritis (U.S. Pat. No. 5,827,256), and reduce development of hypercholesterolemic atherosclerosis in animals (Atherosclerosis 132: 69-76 (1997)), along with numerous reports on the potential antioxidant (Mol. & Cell. Biochem. 202:91-100 (1999)) and anticancer properties (Anticancer Research 18:1405-1408 (1998)).

Lignan can be added to the cocoa powder of the present invention for regular administration to help treat conditions associated with reducing cholesterol levels, treating benign prostatic hyperplasia, treating heart disease, preventing hypercholesterolemic artherosclerosis, reducing heart disease, lowering serum cholesterol, reducing ischemic damage, increasing nitric oxide expression in endothelial cells, inhibiting cyclooxygenase activity in macrophages, alleviating symptoms associated with diabetes, preventing or delaying the onset of diabetes, modulating serum glucose levels, increasing bone density, reducing loss of bone density, alleviating symptoms associated with arthiritis, reducing the risk of prostate cancer, reducing the risk of metastasis, delaying metastasis, alleviating symptoms associated with the onset of menstruation, alleviating symptoms associated with the onset of menopause, lowering blood pressure, or reducing hair loss or male pattern baldness.

Flaxseed (Linum usitatissimum) is potentially the richest source of phytoestrogens including lignans. The primary lignan found in flaxseed is 2,3-bis (3-methoxy-4-hydroxybenzyl) butane-1,4-diol (secoisolariciresinol) which is stored as the conjugate secoisolariciresinol diglucoside (SDG) in its native state in the plant. Flax seed contains levels of these phytoestrogens that are 75-800 times greater than any other plant food. The plant lignan, catecholic nordihydroguaiaretic acid, is a potent antioxidant previously used by the food industry. The flax lignans can also be used in the form of isolated fiber, pressed oil, or extracted, for instance, according to the process disclosed in U.S. Pat. No. 6,767,565. The lignans may also be obtained from the process described in U.S. Provisional Patent Application 60/742,082, filed Dec. 2, 2005, the contents of the entirety of which are incorporated herein by this reference.

The cocoa powder as described herein can be fortified with sterols, or it can be fortified with sterols and lignan.

In this regard, the Food and Drug Administration (“FDA”) of the United States has specifically defined “enriched” and “fortified.” According to the FDA, to say that a food, food product or food ingredient has been “enriched” with a substance means that the substance has been added so that the amount of the substance is approximately equal to that found in unprocessed foods, food products or food ingredients, while to say that a food, food product or food ingredient has been “fortified” with a substance means that the food, food product or food ingredient contains more of the substance than it did originally. However, as used herein, “fortified” and “enriched” are used interchangeably, and are intended to mean that the amount of phytosterol in the finished cocoa powder is higher than it would be had the cocoa powder not been made according to the invention described herein.

As used herein, phytosterol, lignan or another compound noted herein is “purified” or “isolated” from its natural source by removing the natural source from its original environment and wholly or partially isolating the lignan or other compound from the components with which it is associated in the natural source. Thus, even when “purified”, the compound may be associated with other components originally existing in the natural source. In the case of a natural source that contains a large amount of the compound, only crude purification may be necessary to suitably purify the compound. For instance, harvesting and crushing of flax seeds to produce flax flour may be all the purification that is necessary to purify lignan in the flax seeds to the desired degree. As used herein, “purified” includes what is commonly understood by the terms “purified” and “concentrated.” The term also is intended to include synthetic forms of the compounds, which are often made in purified form, and need no actual purification per se. For instance, a commercially-available form of tocopherol would not ordinarily need to be further purified before being included in the compositions as described herein. As used herein, “dietary supplement” includes a formulation that is intended to be consumed in addition to a person's normal daily diet.

Cocoa powder is prepared from cacao seeds or beans. When making cocoa powder, the cacao beans are fermented and dried. The beans are cleaned, deshelled, optionally alkalized, roasted, and broken into small pieces called nibs. The nibs are ground or milled to prepare a thick paste known as cocoa liquor or cocoa mass. Cocoa liquor contains about half cocoa butter and half cocoa solids and is the principal constituent of unsweetened baking chocolate. The cocoa liquor can be pressed to separate the cocoa butter from the solid cocoa powder.

During grinding to make cocoa liquor, the fats within the nibs melt, moisture is lost, and the nibs are reduced to paste. Modern mills are cooled, and can be of several types, including horizontal millstone-types, pin or hammer mills in combination with roller mills, or ball or bead mills. Grinding is often done in stages so as to progressively reduce the particle size. During grinding, the particle sizes may be reduced to 90-120 μm. The particle size of the downstream cocoa products may be determined at this stage, and if a finer particle size is desired, such as for fine desserts, the grinding is continued until the desired particle size is reached.

The liquor can be heated to remove moisture, to reduce the acidity, and to kill microbes. Heating is generally done with the liquor in a thin film. Undesirable flavors are also removed with the moisture.

The liquor is pressed, for example, by a hydraulic press. In a hydraulic press, pots within the press are filled with hot liquor under pressure. Once the pots are filled, the pressure is increased, and the cocoa butter is expressed through, for example, steel mesh filters and removed. The cocoa presscake remaining in the pots after pressing has a remaining fat content of from 8% to 24%, with 10-12% being common. After pressing, the large disk-like cakes are removed. In an expeller press, a rotating screw forces the liquor into a tapering barrel, which has narrow, slit-like perforations through which the fat is expelled. An opening at the end of the barrel allows the material to emerge in the form of defatted expeller presscake. The fat content remaining in presscake from an expeller press ranges from 6-24%, or more usually, 8-10%.

As used herein, the term “cocoa presscake” refers to the material remaining after cocoa fat has been removed from cocoa liquor. The removal can be by the means of various pressed, as described above. The removal of the cocoa fats can also be by chemical means, such as, but not limited to, by means of solvents. The term “cocoa presscake” is, therefore, intended to refer to cocoa solids remaining after removal, by any of a variety of means, of all or a part of the cocoa fats.

After removal of the expressed cocoa butter, presscake is ground to produce cocoa powder. First, the cake is broken up into pea-sized kibbles called cocoa cake. The cocoa cake can be stored or milled further. Different batches of cocoa cake can also be combined (blended).

The cocoa cake (blended or unblended) may be pulverized in mills, disintegrators, and the like, to the particle size that existed previously in the cocoa liquor. The particle size range need not be reduced during milling of presscake to powder. That is, the final particle size of the cocoa powder may actually be that found in the liquor. Therefore, if a very fine particle size is required in the cocoa powder, the liquor may be ground until the desired particle size is achieved.

The cake may be cooled and stabilized while it is ground to powder, so that the fat remaining in the cake does not melt. The temperature may be maintained below 34° C. for presscake containing 20% fat or more. Impact milling at 5-10° C. may be employed for most cocoa powders. For cake containing 12% fat or less, air cooling may be sufficient. For high-fat cake, the grinding process may be cryogenically cooled.

The humidity of the cooling air may also be controlled so that the cocoa powder does not absorb too much moisture (leading to bacterial growth), or become too dry (leading to static electricity problems).

Different batches of cocoa cake may also be blended together to produce a more homogeneous product. Cocoa powder can also be “standardized,” that is, cocoa buffer can be added back to the cocoa powder in order to produce cocoa powder of a specified fat content.

Any phytosterol compound can be used in the present invention. By “phytosterol” is meant the various phytosterols and their hydrogenated stanols, and also the esters of the phytosterols and their hydrogenated stanols. Such phytosterols include, but are not limited to, avenasterol, avenastanol, D5-avenasterol, D5-avenastanol, D7-avenasterol and D7-avenastanol, and their esters; brassicasterol and brassicastanol, and their esters; campesterol and campestanol, and their esters (such as, but not limited to, campesterol laurate ester, campestanol laurate ester, campesterol linoleate ester, campestanol linoleate ester, campesterol myristearate ester, campestanol myristearate ester, campesterol oleate ester, campestanol oleate ester, campesterol ricinoleate ester, campestanol ricinoleate ester, campesterol stearate ester, and campestanol stearate ester); sitosterol, sitostanol, alpha-sitosterol, alpha-sitostanol, beta-sitosterol, beta-sitostanol, gamma-sitosterol and gamma-sitostanol, and their esters (such as, but not limited to, alpha-sitosterol laurate ester, alpha-sitostanol laurate ester, alpha-sitosterol myristearate ester, alpha-sitostanol myristearate ester, alpha-sitosterol oleate ester, alpha-sitostanol oleate ester, alpha-sitosterol stearate ester, alpha-sitostanol stearate ester, beta-sitosterol laurate ester, beta-sitostanol laurate ester, beta-sitosterol linoleate ester, beta-sitostanol-linoleate ester, beta-sitosterol myristearate ester, beta-sitostanol myristearate ester, beta-sitosterol oleate ester, beta-sitostanol oleate ester, beta-sitosterol palmitate ester, beta-sitostanol palmitate ester, beta-sitosterol ricinoleate ester, beta-sitostanol ricinoleate ester, gamma-sitosterol laurate ester, gamma-sitostanol laurate ester, gamma-sitosterol oleate ester, gamma-sitostanol oleate ester, gamma-sitosterol palmitate ester, gamma-sitostanol palmitate ester, gamma-sitosterol stearate ester and gamma-sitostanol stearate ester); stigmasterol, stigmastanol, D7-stigmasterol and D7-stigmastanol, and their esters (such as, but not limited to, stigmasterol caprate ester, stigmastanol caprate ester, stigmasterol laurate ester, stigmastanol laurate ester, stigmasterol linoleate ester, stigmastanol linoleate ester, stigmasterol oleate ester, stigmastanol oleate ester, stigmasterol ricinoleate ester, stigmastanol ricinoleate ester, stigmasterol stearate ester and stigmastanol stearate ester). The term “phytosterols” also includes mixtures of any of the above.

For example, the phytosterols that may be added to the cocoa powder of the present invention include, but are not limited to, brassicasterol, campesterol, stigmasterol, D7-stigmasterol, sitosterol, beta-sitosterol, D5-avenasterol, and D7-avenasterol, and their esters, and their hydrogenated stanols, including, but not limited to, brassicastanol, campestanol, stigmastanol, D7-stigmastanol, sitostanol, beta-sitostanol, D5-avenastanol and D7-avenastanol, and their esters, or mixtures of any of the above.

The phytosterols and the lignans can be added at several points in cocoa powder production. For instance, they can be added to the presscake after the cocoa butter has been expressed. The sterols and lignans can also be added during grinding/milling of the cocoa cake to powder, or during blending of different batches of cocoa powder. They can also be added at more than one of these points. The phytosterols and lignans can be added to a combination of cocoa presscake and cocoa powder.

The phytosterols may be added at a rate of about 0.1 grams to about 600 grams of free phytosterols to each kilogram of cocoa cake or powder, may be added at a rate of about 100 grams to about 300 grams of free phytosterols to each kilogram of cocoa cake or powder, or may be added at a rate of about 200 grams of free phytosterols to each kilogram of cocoa cake or powder. The examples below describe the addition of phytosterols to cocoa presscake (Example 1), to powder during grinding (Example 2) and to powder during blending (Example 3). The three examples describe addition of phytosterols at a rate of about 200 grams of phytosterols to one kilogram of cocoa powder. However, other amounts can be added, depending on the intended sterol level per serving of the finished food product.

Steryl esters contain about 65% free sterols, and therefore the inclusion rates of steryl esters should be increased so as to provide equivalent levels of free sterols.

Generally, use of presscake with a lower fat content will allow greater amounts of phytosterols to be added. Accordingly, in certain embodiments of the present invention, it may be desirable to use presscake with a fat content that is below 20%, in some embodiments having a fat content below 16%, and in other embodiments having a fat content that may be 12% or lower.

Lignans also can be added to the cocoa presscake, cocoa powder, or combination thereof. In general, the lignans can be added at a rate that achieves a target delivery of about 100 mg to about 500 mg of lignan per serving of the finished food product.

The addition of phytosterols to the presscake may be performed in a manner similar to that of alkalizing cocoa cake, wherein aqueous alkali solution may be added to the kibbled cake in a rotating vacuum drum heated at a low temperature. In the alkalization process, the heating also dries the cake. When phytosterols are added, drying is less important.

The invention also includes products and ingredients into which the sterol-fortified cocoa powder has been incorporated, and which are intended to in turn be incorporated into food products. For instance, the sterol-fortified cocoa powder described herein can be incorporated into food products directly, or can be incorporated into chocolate-flavored coatings or liquids including, but not limited to, syrups, coatings, molten compositions, etc. The sterol-fortified cocoa powder can also be incorporated into chocolate-flavored solid compositions including, but not limited to, slabs, chunks, inclusions, wafers, chips, drops, flakes, etc.

According to other embodiments, any of the methods described herein may further include the steps of placing the composition in a container which may be configured for shipping. The methods may further comprise associating indicia with the container, such as, for example, placing graphical, written, or numerical indicia on the container. The indicia may be capable of describing the contents of the container, designating the producer of the contents, and/or directing an end user, such as, for example, a food manufacturer, on how to use the composition in the production of a food product. According to other embodiments, the methods may further comprise shipping the container containing the composition. Any conventional method of shipping may be used, such as, for example, shipping by truck, train, ship, or plane.

The cocoa powder fortified with phytosterols can be used in any food product in which unfortified cocoa powder or chocolate is currently or can be used, such as, but not limited to, chocolate-flavored food products, food products enrobed in chocolate or a chocolate flavored coating, filled with chocolate flavored filling, or food products containing pieces that are flavored with or include cocoa powder or chocolate as an ingredient. For instance, the fortified cocoa powder as described can be used in beverages (such as, but not limited to, dairy or non-dairy beverages, e.g., hot cocoa, chocolate milk, chocolate-flavored soy or rice “milk” or yogurt-based beverages or other fermented dairy products, soft drinks, coffees, colas, dry powder beverage mixes, liquid meal beverages, meal replacement beverages, diet beverages, shakes, frappes, etc.), ice cream and other frozen confections and desserts (such as, but not limited to, ice cream, soft-serve ice cream, frozen yogurt, sherbet, sorbet, soy or other non-dairy frozen confections, frozen bars, cones, cups, etc., all of which can be flavored with, coated, filled with or otherwise include chocolate and cocoa powder), snack bars and meal bars (such as, but not limited to, cold-extruded bars, chocolate flavored bars, enrobed bars, bars containing chocolate, chocolate fillings or chocolate-flavored pieces), snack pieces (such as, but not limited to, chocolate flavored snacks, enrobed snacks or snack pieces), cereals (e.g., chocolate flavored cereals, cereals containing chocolate pieces, extruded or coated cereals, etc.), baked goods that are flavored, enrobed in, filled with or otherwise include chocolate (such as, but not limited to, cakes, cupcakes, brownies, cookies, wafers, biscuits, dessert bars, pies, etc., and fillings for these), confectionary (such as, but not limited to, flavorings, coating, fillings, decorations, etc.), and other food products (such as, but not limited to, doughnuts or other deep-fried items) and food decorating products that regularly incorporate cocoa or chocolate in some form (such as, but not limited to, frostings, syrups, drizzles, flavoring chips and pieces, “sprinkles,” etc.). The compositions described herein can also be included in any mixes or consumer or food service preparations for any of these products.

Cocoa powder is used at different levels in different consumer end products, and the phytosterols can be added to the cocoa cake at different levels, depending on the consumer end product in which the cocoa powder is intended to be used. For instance, chocolate flavored beverages or ice cream typically contain about 1% to about 5% cocoa, while snack goods enrobed in chocolate-flavored compounds typically contain about 3% to about 15% cocoa, and a chocolate-flavored confection can contain about 3% to about 30% cocoa. Cookies, cakes and brownies can contain from about 3% to about 10% cocoa. A manufacturer or ice cream would therefore want to use a cocoa powder of the invention that contained a relatively high level of phytosterols, in order to achieve a particular sterol content per serving. A manufacturer of a chocolate-flavored confection will use much higher amounts of the cocoa powder of the invention in the product, and so will prefer to use cocoa powder containing less sterol, in order to achieve the same sterol content per serving.

Likewise, serving sizes vary between food products. For instance, soft drinks (e.g., chocolate milk) are typically about 240 grams per serving, while ice cream is about 120 grams per serving. Cake is often about 80 grams per serving, and brownies, cookies and snack bars are about 40 grams per serving. One of ordinary skill therefore will study the cocoa content per serving of the intended finished product and use a cocoa powder that has been fortified with free phytosterols to a level that will ensure delivery of a particular sterol amount per serving. For instance, one can formulate a food product to deliver about 400 to about 1000 mg of phytosterols in a single serving. Likewise, a food product can be formulated to deliver about 100 mg to about 500 mg of lignan in a single serving.

Table 1, below, provides guidance on possible dosing levels of cocoa powder with sterols, depending on the serving size and cocoa powder content of the finished food product.

For instance, for an ice cream formulation containing 3% cocoa powder, a 240 gram serving would have 720 mg of free sterols if the formulation used cocoa powder fortified at a rate of 100 grams of free sterols per kilogram of cocoa powder. Likewise, a 40-gram enrobed snack bar containing 12% cocoa powder by weight would contain 480 mg of phytosterols per serving if the cocoa powder used was fortified at a rate of 100 grams of free sterols per kilogram cocoa powder, and 960 mg and 1440 mg if the cocoa powder were fortified at rates of 200 and 300 grams sterols per kilogram, respectively.

Food products made with phytosterol-enriched cocoa powder can also be formulated to contain less fat than food products made with non-enriched cocoa powder, e.g., so that the food product can qualify for a health claim approved by the U.S. Food and Drug Administration. The formulations of food products, and the addition or removal of various ingredients (such as, but not limited to, fats) can also be changed over time, as new information is discovered regarding human nutrition. The amount of the sterol-fortified cocoa powder used in a food product can also be altered, as new information becomes available regarding the health benefits of sterols in the human diet.

TABLE 1
Levels of free sterols per serving in products of varying serving sizes, made
with varying percentages of fortified cocoa powder.

| | Product with 1% cp content, | | | Product with 2% cp content, | | | Product with 3% cp content, | | |
|---|---|---|---|---|---|---|---|---|---|
| | made with cp containing: | | | made with cp containing: | | | made with cp containing: | | |
| Grams | 100 gm | 200 gm | 300 gm | 100 gm | 200 gm | 300 gm | 100 gm | 200 gm | 300 gm |
| per | fs per | fs per | fs per | fs per | fs per | fs per | fs per | fs per | fs per |
| serving | kg cp | kg cp | kg cp | kg cp | kg cp | kg cp | kg cp | kg cp | kg cp |
| | 0.4 gm cp/serving contains: | | | 0.8 gm cp/serving contains: | | | 1.2 gm cp/serving contains: | | |
| 40 gm | 40 mg | 80 mg | 120 mg | 80 mg | 160 mg | 240 mg | 120 mg | 240 mg | 360 mg |
| serving | fs/ | fs/ | fs/ | fs/ | fs/ | fs/ | fs/ | fs/ | fs/ |
| | serving | serving | serving | serving | serving | serving | serving | serving | serving |
| | 0.6 gm cp/serving contains: | | | 1.2 gm cp/serving contains: | | | 1.8 gm cp/serving contains: | | |
| 60 gm | 60 mg | 120 mg | 180 mg | 120 mg | 240 mg | 360 mg | 180 mg | 360 mg | 540 mg |
| serving | fs/ | fs/ | fs/ | fs/ | fs/ | fs/ | fs/ | fs/ | fs/ |
| | serving | serving | serving | serving | serving | serving | serving | serving | serving |
| | 0.8 gm cp/serving contains: | | | 1.6 gm cp/serving contains: | | | 2.4 gm cp/serving contains: | | |
| 80 gm | 80 mg | 160 mg | 240 mg | 160 mg | 320 mg | 480 mg | 240 mg | 480 mg | 720 mg |
| serving | fs/ | fs/ | fs/ | fs/ | fs/ | fs/ | fs/ | fs/ | fs/ |
| | serving | serving | serving | serving | serving | serving | serving | serving | serving |
| | 1.0 gm cp/serving contains: | | | 2.0 gm cp/serving contains: | | | 3.0 gm cp/serving contains: | | |
| 100 gm | 100 mg | 200 mg | 300 mg | 200 mg | 400 mg | 600 mg | 300 mg | 600 mg | 900 mg |
| serving | fs/ | fs/ | fs/ | fs/ | fs/ | fs/ | fs/ | fs/ | fs/ |
| | serving | serving | serving | serving | serving | serving | serving | serving | serving |
| | 1.2 gm cp/serving contains: | | | 2.4 gm cp/serving contains: | | | 3.6 gm cp/serving contains: | | |
| 120 gm | 120 mg | 240 mg | 360 mg | 240 mg | 480 mg | 720 mg | 360 mg | 720 mg | 1080 mg |
| serving | fs/ | fs/ | fs/ | fs/ | fs/ | fs/ | fs/ | fs/ | fs/ |
| | serving | serving | serving | serving | serving g | serving | serving | serving | serving |
| | 1.6 gm cp/serving contains: | | | 3.2 gm cp/serving contains: | | | 4.8 gm cp/serving contains: | | |
| 160 gm | 160 mg | 320 mg | 480 mg | 320 mg | 640 mg | 960 mg | 480 mg | 960 mg | 1440 mg |
| serving | fs/ | fs/ | fs/ | fs/ | fs/ | fs/ | fs/ | fs/ | fs/ |
| | serving | serving | serving | serving | serving | serving | serving | serving | serving |
| | 2.0 gm cp/serving contains: | | | 4.0 gm cp/serving contains: | | | 6.0 gm cp/serving contains: | | |
| 200 gm | 200 mg | 400 mg | 600 mg | 400 mg | 800 mg | 1200 mg | 600 mg | 1200 mg | 1800 mg |
| serving | fs/ | fs/ | fs/ | fs/ | fs/ | fs/ | fs/ | fs/ | fs/ |
| | serving | serving g | serving | serving | serving | serving | serving | serving | serving |
| | 2.4 gm cp/serving contains: | | | 4.8 gm cp/serving contains: | | | 7.2 gm cp/serving contains: | | |
| 240 gm | 240 mg | 480 mg | 720 mg | 480 mg | 960 mg | 1440 mg | 720 mg | 1440 mg | 2160 mg |
| serving | fs/ | fs/ | fs/ | fs/ | fs/ | fs/ | fs/ | fs/ | fs/ |
| | serving | serving | serving | serving | serving | serving | serving | serving | serving |
| | Product with 4% cp content, | | | Product with 5% cp content, | | | Product with 6% cp content, | | |
| | made with cp containing: | | | made with cp containing: | | | made with cp containing: | | |
| Grams | 100 gm | 200 gm | 300 gm | 100 gm | 200 gm | 300 gm | 100 gm | 200 gm | 300 gm |
| per | fs per | fs per | fs per | fs per | fs per | fs per | fs per | fs per | fs per |
| serving | kg cp | kg cp | kg cp | kg cp | kg cp | kg cp | kg cp | kg cp | kg cp |
| | 1.6 gm cp/serving contains: | | | 2.0 gm cp/serving contains: | | | 2.4 gm cp/serving contains: | | |
| 40 gm | 160 mg | 320 mg | 480 mg | 200 mg | 400 mg | 600 mg | 240 mg | 480 mg | 720 mg |
| serving | fs/ | fs/ | fs/ | fs/ | fs/ | fs/ | fs/ | fs/ | fs/ |
| | serving | serving | serving | serving | serving | serving | serving | serving | serving |
| | 2.4 gm cp/serving contains: | | | 3.0 gm cp/serving contains: | | | 3.6 gm cp/serving contains: | | |
| 60 gm | 240 mg | 480 mg | 720 mg | 300 mg | 600 mg | 900 mg | 360 mg | 720 mg | 1080 mg |
| serving | fs/ | fs/ | fs/ | fs/ | fs/ | fs/ | fs/ | fs/ | fs/ |
| | serving | serving | serving | serving | serving | serving | serving | serving | serving |
| | 3.2 gm cp/serving contains: | | | 4.0 gm cp/serving contains: | | | 4.8 gm cp/serving contains: | | |
| 80 gm | 320 mg | 640 mg | 960 mg | 400 mg | 800 mg | 1200 mg | 480 mg | 960 mg | 1440 mg |
| serving | fs/ | fs/ | fs/ | fs/ | fs/ | fs/ | fs/ | fs/ | fs/ |
| | serving | serving | serving | serving | serving | serving | serving | serving | serving |
| | 4.0 gm cp/serving contains: | | | 5.0 gm cp/serving contains: | | | 6.0 gm cp/serving contains: | | |
| 100 gm | 400 mg | 800 mg | 1200 mg | 500 mg | 1000 mg | 1500 mg | 600 mg | 1200 mg | 1800 mg |
| serving | fs/ | fs/ | fs/ | fs/ | fs/ | fs/ | fs/ | fs/ | fs/ |
| | serving | serving | serving | serving | serving | serving | serving | serving | serving |
| | 4.8 gm cp/serving contains: | | | 6.0 gm cp/serving contains: | | | 7.2 gm cp/serving contains: | | |
| 120 gm | 480 mg | 960 mg | 1440 mg | 600 mg | 1200 mg | 1800 mg | 720 mg | 1440 mg | 2160 mg |
| serving | fs/ | fs/ | fs/ | fs/ | fs/ | fs/ | fs/ | fs/ | fs/ |
| | serving | serving | serving | serving | serving | serving | serving | serving | serving |
| | 6.4 gm cp/serving contains: | | | 8.0 gm cp/serving contains: | | | 9.6 gm cp/serving contains: | | |
| 160 gm | 640 mg | 1280 mg | 1920 mg | 800 mg | 1600 mg | 2400 mg | 960 mg | 1920 mg | 2880 mg |
| serving | fs/ | fs/ | fs/ | fs/ | fs/ | fs/ | fs/ | fs/ | fs/ |
| | serving | serving | serving | serving | serving | serving | serving | serving | serving |
| | 8.0 gm cp/serving contains: | | | 10.0 gm cp/serving contains: | | | 12.0 gm cp/serving contains: | | |
| 200 gm | 800 mg | 1600 mg | 2400 mg | 1000 mg | 2000 mg | 3000 mg | 1200 mg | 2400 mg | 3600 mg |
| serving | fs/ | fs/ | fs/ | fs/ | fs/ | fs/ | fs/ | fs/ | fs/ |
| | serving | serving | serving | serving | serving | serving | serving | serving | serving |
| | 9.6 gm cp/serving contains: | | | 12.0 gm cp/serving contains: | | | 14.4 gm cp/serving contains: | | |
| 240 gm | 960 mg | 1920 mg | 2880 mg | 1200 mg | 2400 mg | 3600 mg | 1440 mg | 2880 mg | 4320 mg |
| serving | fs/ | fs/ | fs/ | fs/ | fs/ | fs/ | fs/ | fs/ | fs/ |
| | serving | serving | serving | serving | serving | serving | serving | serving | serving |
| | Product with 7% cp content, | | | Product with 8% cp content, | | | Product with 9% cp content, | | |
| | made with cp containing: | | | made with cp containing: | | | made with cp containing: | | |
| Grams | 100 gm | 200 gm | 300 gm | 100 gm | 200 gm | 300 gm | 100 gm | 200 gm | 300 gm |
| per | fs per | fs per | fs per | fs per | fs per | fs per | fs per | fs per | fs per |
| serving | kg cp | kg cp | kg cp | kg cp | kg cp | kg cp | kg cp | kg cp | kg cp |
| | 2.8 gm cp/serving contains: | | | 3.2 gm cp/serving contains: | | | 3.6 gm cp/serving contains: | | |
| 40 gm | 280 mg | 560 mg | 840 mg | 320 mg | 640 mg | 960 mg | 360 mg | 720 mg | 1080 mg |
| serving | fs/ | fs/ | fs/ | fs/ | fs/ | fs/ | fs/ | fs/ | fs/ |
| | serving | serving | serving | serving | serving | serving | serving | serving | serving |
| | 4.2 gm cp/serving contains: | | | 4.8 gm cp/serving contains: | | | 5.4 gm cp/serving contains: | | |
| 60 gm | 420 mg | 840 mg | 1260 mg | 480 mg | 960 mg | 1440 mg | 540 mg | 1080 mg | 1620 mg |
| serving | fs/ | fs/ | fs/ | fs/ | fs/ | fs/ | fs/ | fs/ | fs/ |
| | serving | serving | serving | serving | serving | serving | serving | serving | serving |
| | 5.6 gm cp/serving contains: | | | 6.4 gm cp/serving contains: | | | 7.2 gm cp/serving contains: | | |
| 80 gm | 560 mg | 1120 mg | 1680 mg | 640 mg | 1280 mg | 1920 mg | 720 mg | 1440 mg | 2160 mg |
| serving | fs/ | fs/ | fs/ | fs/ | fs/ | fs/ | fs/ | fs/ | fs/ |
| | serving | serving | serving | serving | serving | serving | serving | serving | serving |
| | 7.0 gm cp/serving contains: | | | 8.0 gm cp/serving contains: | | | 9.0 gm cp/serving contains: | | |
| 100 gm | 700 mg | 1400 mg | 2100 mg | 800 mg | 1600 mg | 2400 mg | 900 mg | 1800 mg | 2700 mg |
| serving | fs/ | fs/ | fs/ | fs/ | fs/ | fs/ | fs/ | fs/ | fs/ |
| | serving | serving | serving | serving | serving | serving | serving | serving | serving |
| | 8.4 gm cp/serving contains: | | | 9.6 gm cp/serving contains: | | | 10.8 gm cp/serving contains: | | |
| 120 gm | 840 mg | 1680 mg | 2520 mg | 960 mg | 1920 mg | 2880 mg | 1080 mg | 2160 mg | 3240 mg |
| serving | fs/ | fs/ | fs/ | fs/ | fs/ | fs/ | fs/ | fs/ | fs/ |
| | serving | serving | serving | serving | serving | serving | serving | serving | serving |
| | 11.2 gm cp/serving contains: | | | 12.8 gm cp/serving contains: | | | 14.4 gm cp/serving contains: | | |
| 160 gm | 1120 mg | 2240 mg | 3360 mg | 1280 mg | 2560 mg | 3840 mg | 1440 mg | 2880 mg | 4320 mg |
| serving | fs/ | fs/ | fs/ | fs/ | fs/ | fs/ | fs/ | fs/ | fs/ |
| | serving | serving | serving | serving | serving | serving | serving | serving | serving |
| | 14.0 gm cp/serving contains: | | | 16.0 gm cp/serving contains: | | | 18.0 gm cp/serving contains: | | |
| 200 gm | 1400 mg | 2800 mg | 4200 mg | 1600 mg | 3200 mg | 4800 mg | 1800 mg | 3600 mg | 5400 mg |
| serving | fs/ | fs/ | fs/ | fs/ | fs/ | fs/ | fs/ | fs/ | fs/ |
| | serving | serving | serving | serving | serving | serving | serving | serving | serving |
| | 16.8 gm cp/serving contains: | | | 19.2 gm cp/serving contains: | | | 21.6 gm cp/serving contains: | | |
| 240 gm | 1680 mg | 3360 mg | 5040 mg | 1920 mg | 3840 mg | 5760 mg | 2160 mg | 4320 mg | 6480 mg |
| serving | fs/ | fs/ | fs/ | fs/ | fs/ | fs/ | fs/ | fs/ | fs/ |
| | serving | serving | serving | serving | serving | serving | serving | serving | serving |
| | Product with 10% cp content, | | | Product with 11% cp content, | | | Product with 12% cp content, | | |
| | made with cp containing: | | | made with cp containing: | | | made with cp containing: | | |
| Grams | 100 gm | 200 gm | 300 gm | 100 gm | 200 gm | 300 gm | 100 gm | 200 gm | 300 gm |
| per | fs per | fs per | fs per | fs per | fs per | fs per | fs per | fs per | fs per |
| serving | kg cp | kg cp | kg cp | kg cp | kg cp | kg cp | kg cp | kg cp | kg cp |
| | 4.0 gm cp/serving contains: | | | 4.4 gm cp/serving contains: | | | 4.8 gm cp/serving contains: | | |
| 40 gm | 400 mg | 800 mg | 1200 mg | 440 mg | 880 mg | 1320 mg | 480 mg | 960 mg | 1440 mg |
| serving | fs/ | fs/ | fs/ | fs/ | fs/ | fs/ | fs/ | fs/ | fs/ |
| | serving | serving | serving | serving | serving | serving | serving | serving | serving |
| | 6.0 gm cp/serving contains: | | | 6.6 gm cp/serving contains: | | | 7.2 gm cp/serving contains: | | |
| 60 gm | 600 mg | 1200 mg | 1800 mg | 660 mg | 1320 mg | 1980 mg | 720 mg | 1440 mg | 2160 mg |
| serving | fs/ | fs/ | fs/ | fs/ | fs/ | fs/ | fs/ | fs/ | fs/ |
| | serving | serving | serving | serving | serving | serving | serving | serving | serving |
| | 8.0 gm cp/serving contains: | | | 8.8 gm cp/serving contains: | | | 9.6 gm cp/serving contains: | | |
| 80 gm | 800 mg | 1600 mg | 2400 mg | 880 mg | 1760 mg | 2640 mg | 960 mg | 1920 mg | 2880 mg |
| serving | fs/ | fs/ | fs/ | fs/ | fs/ | fs/ | fs/ | fs/ | fs/ |
| | serving | serving | serving | serving | serving | serving | serving | serving | serving |
| | 10.0 gm cp/serving contains: | | | 11.0 gm cp/serving contains: | | | 12.0 gm cp/serving contains: | | |
| 100 gm | 1000 mg | 2000 mg | 3000 mg | 1100 mg | 2200 mg | 3300 mg | 1200 mg | 2400 mg | 3600 mg |
| serving | fs/ | fs/ | fs/ | fs/ | fs/ | fs/ | fs/ | fs/ | fs/ |
| | serving | serving | serving | serving | serving | serving | serving | serving | serving |
| | 12.0 gm cp/serving contains: | | | 13.2 gm cp/serving contains: | | | 14.4 gm cp/serving contains: | | |
| 120 gm | 1200 mg | 2400 mg | 3600 mg | 1320 mg | 2640 mg | 3960 mg | 1440 mg | 2880 mg | 4320 mg |
| serving | fs/ | fs/ | fs/ | fs/ | fs/ | fs/ | fs/ | fs/ | fs/ |
| | serving | serving | serving | serving | serving | serving | serving | serving | serving |
| | 16.0 gm cp/serving contains: | | | 17.6 gm cp/serving contains: | | | 19.2 gm cp/serving contains: | | |
| 160 gm | 1600 mg | 3200 mg | 4800 mg | 1760 mg | 3520 mg | 5280 mg | 1920 mg | 3840 mg | 5760 mg |
| serving | fs/ | fs/ | fs/ | fs/ | fs/ | fs/ | fs/ | fs/ | fs/ |
| | serving | serving | serving | serving | serving | serving | serving | serving | serving |
| | 20.0 gm cp/serving contains: | | | 22.0 gm cp/serving contains: | | | 24.0 gm cp/serving contains: | | |
| 200 gm | 2000 mg | 4000 mg | 6000 mg | 2200 mg | 4400 mg | 6600 mg | 2400 mg | 4800 mg | 7200 mg |
| serving | fs/ | fs/ | fs/ | fs/ | fs/ | fs/ | fs/ | fs/ | fs/ |
| | serving | serving | serving | serving | serving | serving | serving | serving | serving |
| | 24.0 gm cp/serving contains: | | | 26.4 gm cp/serving contains: | | | 28.8 gm cp/serving contains: | | |
| 240 gm | 2400 mg | 4800 mg | 7200 mg | 2640 mg | 5280 mg | 7920 mg | 2880 mg | 5760 mg | 8640 mg |
| serving | fs/ | fs/ | fs/ | fs/ | fs/ | fs/ | fs/ | fs/ | fs/ |
| | serving | serving | serving | serving | serving | serving | serving | serving | serving |

“mg” = milligram
“gm” = gram
“kg” = kilogram
“cp” = cocoa powder
“fs” = free sterols

It is understood that the manufacturer of a given food product is always free to replace all or a part of the cocoa powder in the food product with the sterol-fortified cocoa powder of the present invention. For instance, the manufacturer of an ice formulation as described above, can reduce the level of sterols provided to 400 mg per 240 gram serving by using a mixture of unfortified cocoa powder and the fortified cocoa powder of the present invention. The manufacturer of a food product is therefore able to use the fortified cocoa powders of the present invention to provide a particular level of free sterols per serving. Such formulations can therefore take into account consumers' eating habits, e.g., consumers may not always limit themselves to a single serving in a 24-hour period, or may consume several servings at a time.

The present invention may be further understood by reference to the following examples. The following examples are merely illustrative of the invention and are not intended to be limiting. Unless otherwise indicated, all parts are by weight.

### EXAMPLES

### Example 1

### Cocoa Powder With Phytosterols Added to Presscake

Fermented, cleaned, deshelled, optionally alkalized and roasted cocoa beans are ground to produce cocoa mass. The cocoa mass is injected into presspots in a hydraulic press, and the cocoa butter is pressed from the mass. The presscakes are emptied from the presspots.

Phytosterols in liquid form are sprayed onto the presscakes at a rate of 200 grams free phytosterols per kilogram of cake. The cakes are broken and ground to produce cocoa powder. The powder is cooled and packaged.

### Example 2

### Cocoa Powder With Phytosterols Added During Grinding and Stabilizing

Fermented, cleaned, deshelled, optionally alkalized and roasted cocoa beans are ground to produce cocoa mass. The cocoa mass is injected into presspots in a hydraulic press, and the cocoa butter is pressed from the mass. The presscakes are emptied from the presspots.

The cakes are broken and ground to produce cocoa powder. During grinding, phytosterols in liquid form are sprayed onto the grinding mixture at a rate of 200 grams free phytosterols per kilogram of cake. Grinding continues until cocoa powder of satisfactory consistency is produced. The powder is cooled and packaged.

### Example 3

### Cocoa Powder With Phytosterols Added During Blending

Several batches of cocoa powder are blended to produce a homogeneous blended cocoa powder. During blending, phytosterols in liquid form are sprayed onto the mixture at a rate of 200 grams free phytosterols per kilogram of powder. Blending continues until cocoa powder of satisfactory consistency is produced. The powder is cooled, if necessary, and packaged.

While this invention has been particularly shown and described with references to preferred embodiments thereof, it will be understood by those skilled in the art that various changes in form and details may be made therein without departing from the scope of the invention encompassed by the appended claims.

1. A method of making an enriched cocoa powder, the method comprising:
combining cocoa presscake, cocoa powder, or a combination of cocoa presscake and cocoa powder with a phytosterol;
thus producing the enriched cocoa powder.

2. The method of claim 1, wherein the phytosterol is selected from the group consisting of brassicasterol, an ester of brassicasterol, campesterol, an ester of campesterol, stigmasterol, an ester of stigmasterol, D7-stigmasterol, an ester of D7-stigmasterol, sitosterol, an ester of sitosterol, beta-sitosterol, an ester of beta-sitosterol, D5-avenasterol, an ester of D5-avenasterol, D7-avenasterol, an ester of D7-avenasterol, a hydrogenated stanol of brassicasterol, a hydrogenated stanol of an ester of brassicasterol, a hydrogenated stanol of campesterol, a hydrogenated stanol of an ester of campesterol, a hydrogenated stanol of stigmasterol, a hydrogenated stanol of an ester of stigmasterol, a hydrogenated stanol of D7-stigmasterol, a hydrogenated stanol of an ester of D7-stigmasterol, a hydrogenated stanol of sitosterol, a hydrogenated stanol of an ester of sitosterol, a hydrogenated stanol of beta-sitosterol, a hydrogenated stanol of an ester of beta-sitosterol, a hydrogenated stanol of D5-avenasterol, a hydrogenated stanol of an ester of D5-avenasterol, a hydrogenated stanol of D7-avenasterol, a hydrogenated stanol of an ester of D7-avenasterol, and any mixtures thereof.

3. The method of claim 1, wherein about 1 gram to about 600 grams phytosterol is added to each kilogram of the cocoa presscake, the cocoa powder or the combination of cocoa presscake and cocoa powder.

4. The method of claim 1, wherein the cocoa presscake, the cocoa powder or the combination of cocoa presscake and cocoa powder is made from cocoa beans which have been alkalized.

5. The method of claim 1, further comprising alkalizing the enriched cocoa powder.

6. The method of claim 1, further comprising admixing the phytosterol in solid form to the cocoa presscake, the cocoa powder, or the combination of cocoa presscake and cocoa powder.

7. The method of claim 1, further comprising:
spraying a liquid form the phytosterol on the cocoa presscake, the cocoa powder, or the combination of cocoa presscake and cocoa powder.

8. The method of claim 1, further comprising admixing the phytosterol in powder form to the cocoa presscake, the cocoa powder, or the combination of cocoa presscake and cocoa powder.

9. The method of claim 1, further comprising:
grinding roasted cocoa beans, thus producing a cocoa mass;
removing cocoa butter from the cocoa mass, thus producing a presscake;
spraying the phytosterol in liquid form onto the presscake; and
grinding the presscake, thus producing the enriched cocoa powder.

10. The method of claim 1, further comprising combining a lignan with the cocoa presscake, the cocoa powder, the combination of cocoa presscake and cocoa powder, or the enriched cocoa powder.

11. A composition comprising:
an isolated or purified phytosterol; and
cocoa powder.

12. The composition of claim 11, wherein the phytosterol is selected from the group consisting of brassicasterol, an ester of brassicasterol, campesterol, an ester of campesterol, stigmasterol, an ester of stigmasterol, D7-stigmasterol, an ester of D7-stigmasterol, sitosterol, an ester of sitosterol, beta-sitosterol, an ester of beta-sitosterol, D5-avenasterol, an ester of D5-avenasterol, D7-avenasterol, an ester of D7-avenasterol, a hydrogenated stanol of brassicasterol, a hydrogenated stanol of an ester of brassicasterol, a hydrogenated stanol of campesterol, a hydrogenated stanol of an ester of campesterol, a hydrogenated stanol of stigmasterol, a hydrogenated stanol of an ester of stigmasterol, a hydrogenated stanol of D7-stigmasterol, a hydrogenated stanol of an ester of D7-stigmasterol, a hydrogenated stanol of sitosterol, a hydrogenated stanol of an ester of sitosterol, a hydrogenated stanol of beta-sitosterol, a hydrogenated stanol of an ester of beta-sitosterol, a hydrogenated stanol of D5-avenasterol, a hydrogenated stanol of an ester of D5-avenasterol, a hydrogenated stanol of D7-avenasterol, a hydrogenated stanol of an ester of D7-avenasterol, and any mixtures thereof.

13. The composition of claim 11, wherein the composition contains about 1 gram to about 600 grams of the phytosterol for each kilogram of the cocoa powder.

14. The composition of claim 11, wherein the composition contains about 100 grams to about 300 grams the phytosterol for each kilogram of the cocoa powder.

15. The composition of claim 11, wherein the composition contains about 200 grams of the phytosterol for each kilogram of the cocoa powder.

16. The composition of claim 11, wherein the cocoa powder is alkalized.

17. The composition of claim 11, further comprising lignan.

18. A food product comprising the composition of claim 11.

19. The food product of claim 17, wherein the food product is configured such that a serving size of the food product provides between 400 to 1000 mg of the phytosterols to a subject consuming the food product.

20. A container configured to hold the food product of claim 17, comprising indicia configured to inform a user of the food product of the phytosterol content of the food product associated with the container.

21. A phytosterol-enriched cocoa powder, made by the method of claim 1.

22-63. (canceled)
